(19) United States
(12) Patent Application Publication
(10) Pub. No.: US 2021/0213635 A1
(43) Pub. Date: Jul. 15, 2021

(54) METHOD AND APPARATUS FOR CUTTING FOOD INTO UNIQUE GEOMETRIC PORTIONS

(71) Applicant: High Liner Foods Incorporated, Portsmouth, NH (US)

(72) Inventors: James Jackman, Portsmouth, NH (US); Allan BEZANSON, Southboro, MA (US)

(21) Appl. No.: 17/086,168

(22) Filed: Oct. 30, 2020

Related U.S. Application Data
(60) Provisional application No. 62/949,132, filed on Dec. 17, 2019.

(51) Int. Cl. B26D 3/00; B26D 1/12

(52) U.S. Cl. CPC B26D 3/00; B26D 2210/02; B26D 1/12

(57) ABSTRACT

An apparatus and method for cutting blocks of frozen food into irregular shapes comprises a slicer unit carrying a cutting blade and chutes for feeding logs of frozen food to said blade. The chute extends from a chute inlet to a chute outlet, having a central longitudinal axis extending from the center of the chute inlet to center of chute outlet. The cutting blade is positioned below the chute outlets wherein said elongate blocks of processed food are fed into said chute inlet through the chute to the chute outlet, to said blade, said blade sectioning the blocks into smaller pieces. The chutes are angled greater than 15 degrees and less than 90 degrees from the plane of the cutting blade and the chute is rotated about its longitudinal axis between 0 to 180 degrees from a square orientation to the plane of the blade.

### CROSS-REFERENCE TO RELATED APPLICATION

This application claims the benefits of priority to U.S. Provisional Patent Application No. 62/949,132, filed Dec. 17, 2019, titled METHOD FOR CUTTING FROZEN FISH, the contents of which are hereby expressly incorporated into the present application by reference in their entirety.

### BACKGROUND ON THE INVENTION

### Field of the Invention

The present invention relates generally to food products, and more particularly to an apparatus and method of dividing frozen processed meat, fish and/or seafood into portions with unique geometry.

### Description of the Prior Art

Processed frozen food such as fish and seafood is commonly formed by feeding frozen blocks into slicing machines from a vertical or near vertical chute or chutes to a horizontal cutting blade (see FIG. 1 for an example). Such known methods and apparatus for preparing processed frozen food meat, seafood and fish product typically create uniform thickness slices like squares, rectangles and diamonds for the product pieces. For example, fish sticks are formed by feeding the rectangular logs of frozen processed fish to the slicing blade, which a rectangular block to create the rectangular fish stick portion. A conveyor below the blade carries the cut portions for further value added processing, such as battering, breading, glazing and packaging.

Known processed food cutting machines are designed to create industry standard cut patterns of uniform thickness, such as squares and rectangles but never anything as unique as 6 sided beveled pieces, creating variable thickness, such as “natural chicken wing” shape. Having multisided or beveled sided cut pieces such as pieces that emulate chicken wing shape is desirable as they are easily held, and have a shape that is conducive to dip-ability, crispiness of edges and tenderness of the product. The variable thickness creates a variable eating texture and moisture profile.

### SUMMARY OF INVENTION

It is an object of the present invention to provide an improved apparatus and method of processing frozen food materials which allows for the creation of multi sided pieces of consumable processed food, such as fish or seafood and for example emulating shape of chicken wings pieces. In accordance with an aspect of the invention, there is provided an apparatus for cutting blocks of frozen processed food into irregular shapes comprising a slicer unit carrying a fixed cutting blade and at least one chute for feeding slabs/logs of said frozen processed food to said blade, said chute defining a chute path for said logs/slabs extending from a chute inlet to a chute outlet, having a central longitudinal axis extending from the center of the chute inlet to center of chute outlet. The cutting blade is positioned below the at least one chute outlet. The elongate blocks of processed food are fed into said chute inlet through the chute to the chute outlet, presented to the blade, with the blade dividing the slabs into smaller portions. The at least one chute is angled greater than 30 degrees and less than 80 degrees from the plane of the cutting blade. The at least one chute is rotated about its longitudinal axis between 0 to 180 degrees and preferably between 20 and 80 degrees from a square orientation to the plane of the blade. The slicer unit may include height adjustment attachments for raising the unit at at least 2 corners thereof. In accordance with an aspect of the invention, the height adjustment attachment is a frame with adjustable castors, raises the unit at a chute inlet side of the unit such that the blade is raised to an angle of at least 18 degrees to the horizontal. In accordance with a further aspect of the invention, the chute inlet side of the unit is raised by approximately 18 degrees position the chute approximately 45 degrees to horizontal ground. As will be discussed below, the opposite side of the unit may be raise with chute orientation altered.

In accordance with a further aspect of the invention, there is provided a method of cutting blocks of food, such as frozen processed seafood of fish, into irregular shapes comprising feeding logs of said food via at least one chute to a horizontally oriented cutting blade; said chute defining a chute path for said logs extending from a chute inlet to a chute outlet, having a central longitudinal axis extending from the center of the chute inlet to center of chute outlet; Said cutting blade positioned below the at least one chute outlet; wherein said logs of food are fed into said chute inlet through the chute to the chute outlet, to said blade, said blade sectioning the blocks into smaller pieces. In accordance with a further aspect of the invention, the at least one chute angled greater than 15 degrees and less than 90 degrees from the plane of the cutting blade and the at least one chute axially rotated about its longitudinal axis between 180 to 0 degrees from a square orientation to the plane of the blade. The at least one chute may be angled at 32 degrees to the plane of the cutting blade. A piece of food such as frozen fish or seafood, produced by the method or apparatus described herein forms an aspect of the invention.

An example slicer which could be utilized with the herein invention is the Ross Orbital Slicer 950-04. It should be understood that any suitable slicer known in the industry could be used. Typical orbital slicers are required to be supported on a level floor per manufacturers operational specifications. The Ross specification and instruction manual stating “operational area of slicing blade must have a floor that is level and free of obstruction”.

Altering the angle of a slicer on a floor to raise the chute angle is not obvious to anyone with ordinary knowledge of food manufacturing. It is not part of the standard operating procedure for use of standard known industrial slicers. Using such machines to cut processed frozen food into 6 sided and/or beveled and/or chicken wing shapes was not an option using traditional methods. The herein invention allow production of a 6 angled frozen processed food (such as fish or seafood) shape in a commercially viable way, rather than hand cutting.

### BRIEF DESCRIPTION OF THE DRAWINGS

FIG. 1 is side view of a known orbital slicer for frozen processed meat;

FIG. 2 is an example of fish shapes cut from the apparatus of the herein invention;

FIG. 3 shows a plurality of chutes attached to a standard orbital slicer in accordance with an example embodiment of the invention;

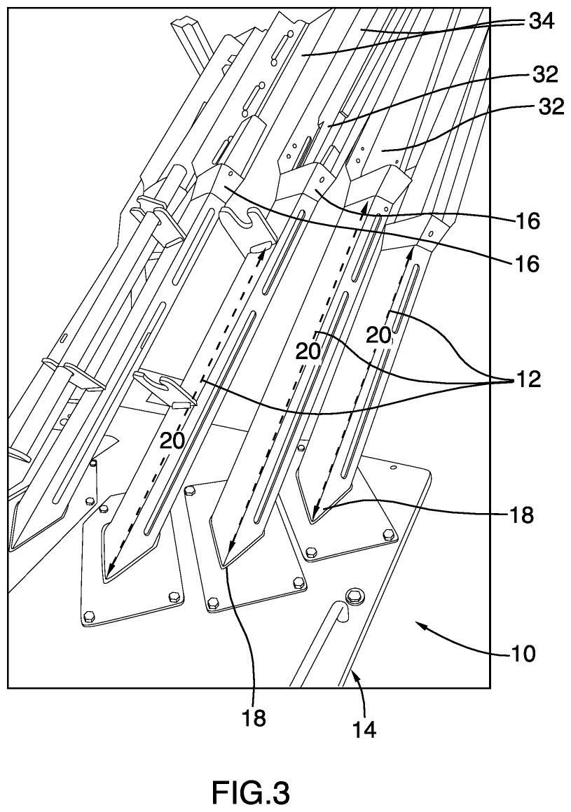

FIG. 4 is a bottom end view of chute outlet ends rotated about their longitudinal axis with the chute angle to blade being visible in accordance with an example embodiment of the invention;

FIG. 5 is a side view of a slicer unit, with angled chutes and height adjustment attachments elevating chute inlet end of unit in accordance with an aspect of the invention;

FIG. 5a is a side view of the a slicer unit with angled chutes and height adjustment attachments elevating the chute outlet end of the unit with chutes repositioned, in accordance with an aspect of the invention;

FIG. 6 illustrates a frame schematic that may be bolted to the base of the slicer unit in an example embodiment of the height adjustment attachments; and

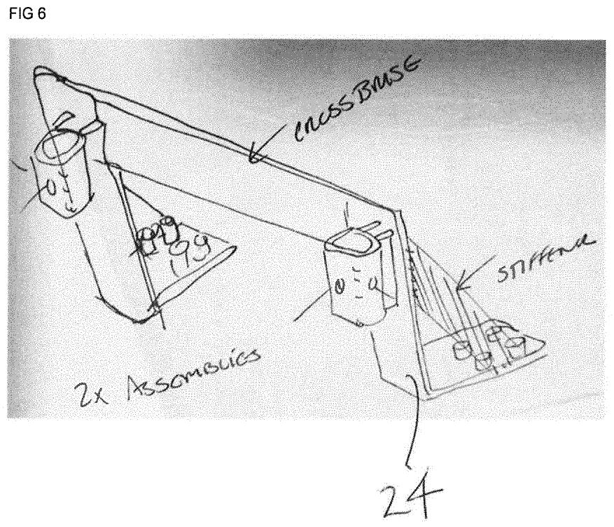

FIGS. 7 and 8 are illustrations of example pieces of processed food cut by the apparatus of the invention.

### DETAILED DESCRIPTION OF EXAMPLE EMBODIMENTS OF THE INVENTION

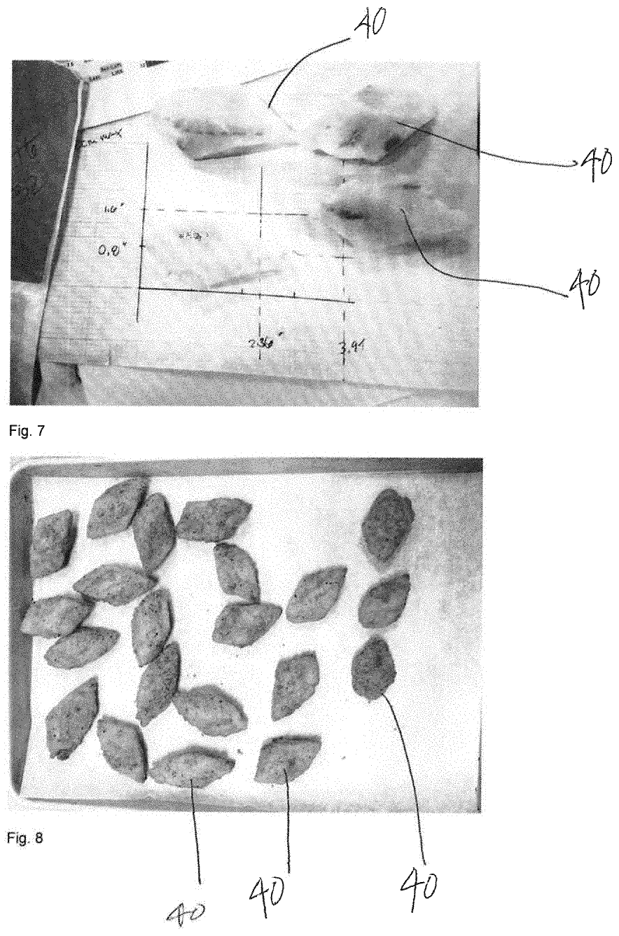

Traditional fish sticks and rectangular fish burgers are cut using vertical chutes to create uniform thickness portions from processed food slabs (also referred to as logs). The present invention relates to a method and apparatus for making a frozen process food product, preferably fish and seafood that has non uniform thickness and produces non rectangular shapes from standard rectangular slabs or logs, such as a 6 sided shape. An example of such shape is the general dimensional appearance of a chicken wing in terms of non rectangular sides and angles such as are shown in FIGS. 7 and 8. In the present invention, an apparatus comprises a fish slicer apparatus (1), having intake chutes (12) above a fixed plane where a slicer blade operates (14), mounted within a slicer unit (10). Below the slicer blade (14) is a conveyor (30) to take cut pieces away for further processing or packaging. As will be described below, vertical and axial angles of the chutes (12), and angle of the slicer blade (14) to the horizontal and are manipulated to create pieces (30) of frozen processed food such as fish or seafood with non rectangular angles and/or with beveled cut angles to emulate chicken wings or the like.

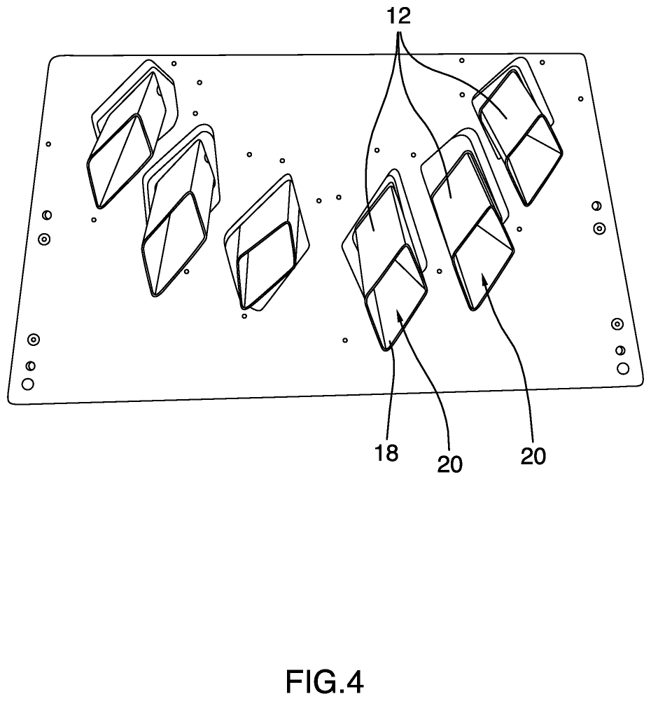

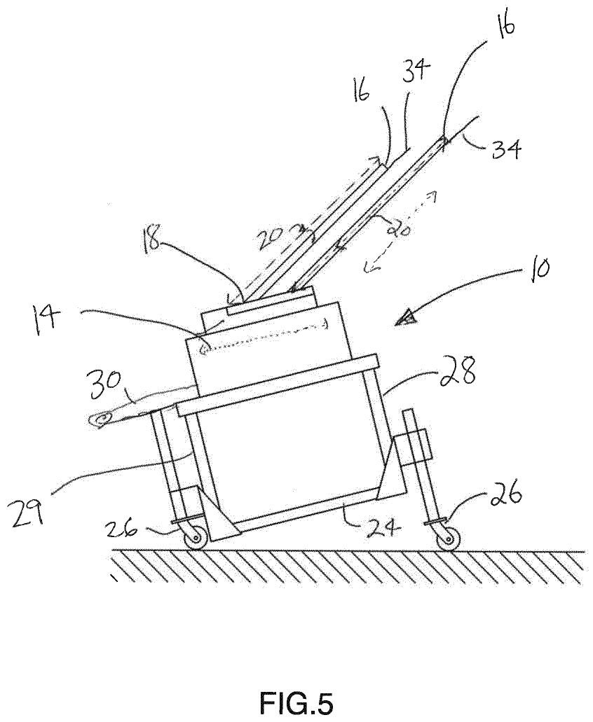

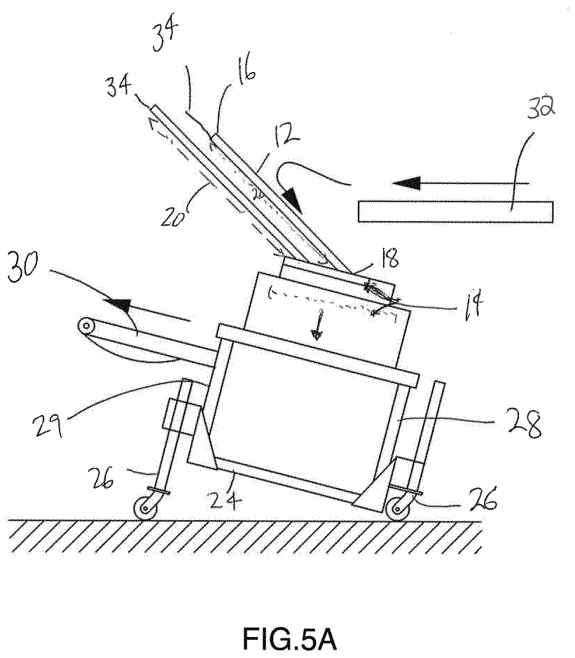

In an example embodiment of the invention, such as shown in FIGS. 5 and 5A, the slicer unit (10) is re-orientated by creating a height adjustment attachment frame (24) around the base or a portion of the base of the slicer unit (10) that can be raised and lowered at each corner. By using modified tooling and chute orientation, the food logs or slabs are presented to the blade within a range of approximately 13 to 90 degrees to the blade and axially between 0 and 180 degrees. In a preferred example embodiment, a height adjustment frame (24) is positioned around the slicer unit (10) that allows the operator to raise and lower corners of the machine by as much as 18 inches at each corner. In an example, this increases the angle of the intake feed by 13% from the standard 90-degree angle. This change in orientation allows personnel to feed the fish slabs/logs (32) into the tooling at non-traditional angles and benefit from gravity assist. The frame (24) is attached to slicing unit (10) by any suitable and known mechanical attachment, such as screws, rivets, clamps, bolts or any other suitable attachment to the base of the slicer unit. The embodiment of the frame shown has height adjustable castors (26) that can be raised and lowered at each corner. As shown in the figures, particularly FIG. 5, the slicer unit (10) is tilted upwardly by the height adjustment frame on the side (28) of the machine, where chute inlets (16) are shown in FIG. 5. In FIG. 5a the slicer unit is tilted upward on the side opposite of that shown in FIG. 5 with the orientation of chutes being adjusted to the opposite side (29) which allows for reduced personnel to operate the machine and possibly to accommodate commercially viable rates dependent of attributes of material being processed. Support frame (24) is positioned at the base of the slicing unit with independent height adjustable castors (26) positioned at least at 2 adjacent corners of the unit, such as shown in FIGS. 4 and 5. In the example shown, the frame and height adjustable casters are attached to the unit (10) at the side of the chute inlet (28), tilting the unit upwardly such that the blade angle to horizontal floor is 13 degrees. It should be understood that the unit may be raised to a different angle.

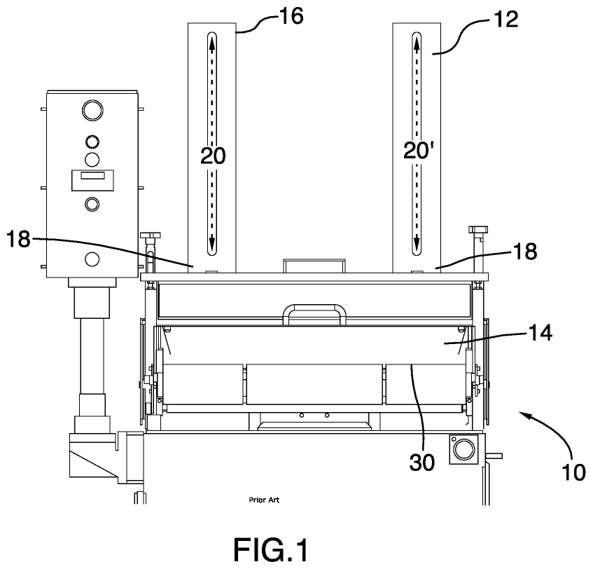

In prior art methods and apparatus, the intake chutes (12) to the orbital slicing blade is vertical (90 degrees to a horizontal cutting blade as is seen if FIG. 1).

In the example embodiment of the herein invention shown in the drawing, the angle of the chute or chutes (12) to the cutting blade (14) itself is preferably 32 degrees. It is understood that this angle may range from between 15 to 90 degrees if desired. It was observed that 32 degrees chute angle to cutting blade in combination of axial rotation of 22 degrees was found to provide the dimensional shape specifications to emulate chicken wings in the finished cut pieces. As shown in FIGS. 7 and 8, in an example of the invention, each processed fish piece (40) portion is cut to be shaped to 14 to 19 g each, with a “6” sided beveled appearance.

Utilizing the apparatus of the present invention, allows for creation from processed frozen fish or seafood a product that looks like and emulates the crisp texture and tenderness of like chicken wings—without the bones. From an example method and apparatus as will be discussed herein, a 6 sided, beveled shaped piece is formed that emulate the chicken wing appearance or other irregular non rectangular shapes. It should be understood that although frozen fish and seafood are specifically described, other blocks of frozen processed food or food that is not frozen and/or processed may be utilized with this machine, such as for example beef, pork, chicken, vegetables or other foods not specifically listed herein.

Block processed frozen fish, the raw material that is used to produce fish sticks and fish rectangle burgers is an example of the food to be used with the herein invention. An example apparatus for cutting blocks of frozen processed food into irregular shapes is shown in the figures, an in particular FIG. 5. A slicer unit (10) carries a horizontally oriented blade (14) and at least one rectangular chute (12). In the example shown, 6 chutes are provided for feeding logs/slabs (32) (also referred to as blocks) of said frozen processed food to said blade (14) shown within the slicer unit in schematic form. The chutes (10) define a chute path for said slabs/logs (32) extending from a chute inlet (16) to a chute outlet (18), having a central longitudinal axis (20) extending from the center of the chute inlet to center of chute outlet. The horizontally oriented rotating cutting blade (14) is positioned below the chute outlets (18). Slabs/logs (32) of processed food are fed into each chute inlet (16) and pass through the chute (12) to the chute outlet (18) to the cutting blade (14). The blade divides the slabs/logs into smaller pieces (30) such as shown in FIGS. 7 and 8. As can be seen in FIG. 5, the chutes (10) are angled at 32 degrees to the blade (14) but in accordance with an aspect of the invention, the angle may be greater than 15 degrees and less than 90 degrees from the horizontal plane of the blade and preferably greater than 30 degrees and less than 80 degrees in an even further embodiment. The chutes (12) are rotated axially around their longitudinal axis (20) between 0 to 180 degrees from a square orientation to the horizontal plane of the blade and preferably 22 degrees. As described above, height adjustment attachment such as frame with adjustable castors shown in FIG. 5/5A, raises the unit at a chute inlet side (28) of the unit such that the horizontal blade is raised to an angle of at least 13 degrees to the horizontal. In the embodiment shown in FIG. 5, the chute inlet side of the unit (10) is raised by 13 degrees to promote gravity feed.

It should be understood that although an array of 6 chutes (12) are present in the example apparatus any suitable orientation or amount of such chutes ranging from 1 to 8 or more could be utilized provided that they can be fit within the zone to feed to the machines fixed blade.

As mentioned above, each rectangular chute is rotated around its central longitudinal axis (20) between 0-180 degrees from square. Square is defined as a position of the chute such that reference plane of the chute is parallel to the plane of cutting blade, such as would be observed in prior art machines. Rotation away from square to the horizontal plane, creates a non-rectangular cut angle to the pieces of processed fish as they are cut by the blade. FIG. 4 shows a bottom view of chutes 12 with rotation around its central longitudinal axis (20) (marked with an X in this figure) from square to the horizontal plane.

As can be seen in FIG. 5, the chute Inlet (16) includes an extended log feeding landing section (34), extending from the chute beyond the inlet end, for placement of the log or logs (32) into the chute (12).

In an example of the invention, the angle of the chutes (12) to a the horizontal plane of the floor surface is at least 45 degrees. The angle of the rotating blade to the horizontal plane is 13 degrees.

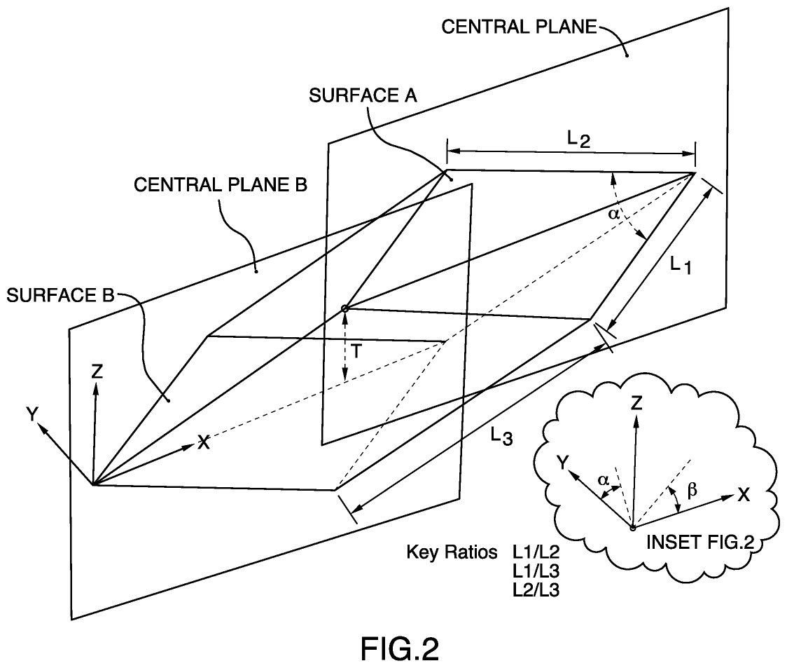

As illustrated in the drawings, FIG. 2 illustrates a preferred embodiment of the invention where the processed food wing shape is defined using the Cartesian coordinate system (x, y, z). The below described shaped are formed by the angles of the chute to blade, longitudinal rotation of the chute from square and the blade angle to horizontal as are described herein.

Surface A is a planar surface that has a parallelogram shape on an x-y plane. Surface B is a planar surface that has a parallelogram shape on an x-y plane. Dimension L1 is a distance on the x-y plane that defines two of four edges of a parallelogram defining the surface of the product shape A&B. Dimension L2 is a distance on the x-y plane that defines two of four edges of the parallelogram defining the surface of shape A&B. Dimension a (alpha) is an angles that defines the acute angle of parallelograms A & B. Dimension T is a distance in the z direction between two product services A and B. Surface B is located on a plane parallel to surface A. Surface B is of identical description to surface A.

Central plane is an imaginary surface necessary to define relative portions of surfaces A and B. The central plane intersects surfaces A and B at the two opposite corners of these surfaces that are furthest apart. Both surface A and surface B have unique central planes and these planes are parallel with the x-y plane.

Dimension B (beta) is an angle that defines the relationship of any identical coordinates x,y within surfaces A and B as a function of dimension T. This angle is relative to the x-axis on the x-z plane and when combined with Dimensions T defines the offset of the two parallelograms in the x coordinate direction.

Dimension (gamma) is an angle that defines the relationship of any identical coordinates x.y within surfaces A and B as a function of T. This angle is relative to the x-axis on the x-y plane and when combined with dimension T, defines the offset of the two parallelograms in the gamma coordinate direction.

Dimension L3 is the distance that is dependent on variables L1, L2, T, B, and gamma.

The ratios, L1/L2, L1/L3, L2/L3 are important marketing values and create the unique appearance and eating experience. This is a level of geometric orientation not seen before in block cut food. The shape enhances the dining experience by presenting variable different types of texture and taste experience. The end tips are more crispy and crunchy, and somewhat drier than the middle of the product. The middle tends to be juicer and provide a more sumptuous eating experience.

The following sets out an example of a step by step method of how the frozen fish block is cut:

19″×10″×2.5″ frozen Fish blocks are processed as follows:

10″ dimension cut into longitudinal quarters, 10/4, creating 19″×2.5″×2.5″ logs

2.5″ dimension is cut into longitudinal quarters again 2.5/4, creating 19″×2.5″×0.625″ slabs

2.5 dimension is cut in longitudinal half again 2.5/2, creating 19″×1.25″×0.625″ rods

These rods/logs (32) are fed into the feed chute landing sections (34) at the chute inlet (16). These logs (32) must be sized to fit for easy sliding fit through the chutes, but cannot be too small in cross section or they will rotate or spin as the blade cuts through it resulting in torn or uneven slices. In a preferred embodiment of the invention 4 logs of 19″×1.25″×0.625″ are placed together in a chute (12) to create the desired size of food pieces. The blade cut location can be adjusted to adjust piece size as per known methods for cutting blades and orbital cutting blades.

In a preferred embodiment of the invention, conveyors take cut pieces from below the slicer for further processing.

In a preferred embodiment, the rectangular rods (32) (now cut to a length of 19″×1.25″×0.625″ drop into 6 chutes (12) at a 32 degree to the orbital blade). Each chute has a longitudinal axis (20) extending from its chute inlet opening (16) to chute outlet (18). From one of its sides being square to the horizontal cutting plane, the rectangular chute is rotated between 20 to 80 degrees about its longitudinal axis. Rotation outside of this range may also be utilized between 0-180 degrees. Chute is rectangular and matches the size and shape of the log or a plurality of rectangular logs (for example 4 said logs having a cross section of 2.5″×1.3″).

As referred to above, at the side (28) of the chute inlet which may vary as shown in FIGS. 5 and 5A, the machine is titled upwardly at an additional 13 degrees such that the blade angle to horizontal is 13 degrees. The upward tilt is achieved by means of a height adjustment support frame casters described above. Other height adjustment means to raise the unit may be utilized as part of the invention, such as by hydraulic, electronic or other elevation support means.

In an example embodiment, the logs are cut into approximately 10 sections with a compound angle to create the final shape and weight, typically 14 to 19 grams. The resultant pieces are formed with 6 sides.

It is the angle in the rotation of chute on its own axis in combination with the angle of chute to the cutting blade, that creates the complex shape of cut pieces (40).

As seen in FIGS. 5 and 5a, angling the chutes from the typical vertical feeding in combination with their longitudinal rotation is required to create the fish wing shape. It is these two angles combined that generates the combined tapered shape—with 4 tapered sides which is unique in such cutting methods.

The present invention is novel and non-obvious over what others skilled in the art have done because the present method is not part of the standard operating procedure for using standard slicing machines. Cutting fish into chicken wing shapes of non uniform thickness was not an option using traditional methods.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention. It should be further understood that the figures may illustrate components of the invention and angles relating to said components in schematic form and may not be an accurate reflection of the dimensions and angles described in the specification. Any discrepancy between dimensions and angles shown in the figures and described in the specification shall be resolved in favour of that described in the specification.

1. An apparatus for cutting blocks of food into irregular shapes comprising:
A slicer unit carrying a horizontally oriented cutting blade and at least one rectangular chute for feeding logs of said food to said blade, said chute defining a chute path for said logs extending from a chute inlet to a chute outlet, having a central longitudinal axis extending from the center of the chute inlet to center of chute outlet;
Said cutting blade positioned below the at least one chute outlet; wherein said logs of food are fed into said chute inlet through the chute to the chute outlet, to said blade, said blade sectioning the blocks into smaller pieces;
Said at least one chute angled greater than 15 degrees and less than 90 degrees from the plane of the cutting blade;
Said at least one chute axially rotated about its longitudinal axis between 180 to 0 degrees from a square orientation to the plane of the blade.

2. An apparatus as recited in claim 1 wherein said slicer unit includes height adjustment attachments for raising said unit at at least 2 corners thereof.

3. An apparatus of claim 1 comprising 4, 6 or 8 said chutes.

4. An apparatus of claim 1 wherein the logs are comprised of frozen processed seafood or fish.

5. Apparatus as recited in claim 1 wherein the logs are shaped and sized to match the shape of the chute path.

6. An apparatus as recited in claim 2 wherein height adjustment attachments comprise a height adjustment support frame secured to the base of the slicing unit with independent height adjustable castors positioned at at least 2 corners of the unit.

7. An apparatus as recited in claim 7 wherein the chute inlet side of the unit is raised by at least 13 degrees to promote gravity feed assist to make commercially viable.

8. Apparatus as recited in claim 2 wherein the chute inlet end of the chute includes an extended log landing section, extending outwardly from the bottom of the chute inlet, for placement of the log or logs into the chute.

9. Apparatus of claim 2 wherein the at least one chute is angled at 32 degrees to the plane of the cutting blade.

10. Apparatus as recited in claim 2 wherein the combined angle of the at least one chute and rotating blade to the floor surface is at least 45 degrees.

11. Apparatus as recited in claim 2 generating fish pieces weighing 14 to 19 g each, with 6 sides.

12. (canceled)

13. Apparatus as recited in claim 2 wherein the rectangular logs are 19×1.25×0.62 in shape and are fed into the chutes of mating size.

14. Apparatus as recited in claim 2 wherein said logs comprise 4 longitudinal precut logs placed together simultaneously to fill the cross section of the chutes.

15. Apparatus as recited in claim 14 wherein said logs comprise four 19″×1.25″×0.625″ placed together and passed into chute simultaneously.

16. (canceled)

17. (canceled)

18. (canceled)

19. Apparatus as recited in claim 1 wherein chute angle is 32 degrees to cutting blade and chute axial rotation is 22 degrees.

20. A method of cutting blocks of food into irregular shapes comprising:
Feeding logs of said food via at least one chute to a horizontally oriented cutting blade; said chute defining a chute path for said logs extending from a chute inlet to a chute outlet, having a central longitudinal axis extending from the center of the chute inlet to center of chute outlet; Said cutting blade positioned below the at least one chute outlet; wherein said logs of food are fed into said chute inlet through the chute to the chute outlet, to said blade, said blade sectioning the blocks into smaller pieces;
Said at least one chute angled greater than 15 degrees and less than 90 degrees from the plane of the cutting blade; Said at least one chute axially rotated about its longitudinal axis between 180 to 0 degrees from a square orientation to the plane of the blade.

21. The method of claim 20 wherein the logs are comprised of frozen processed seafood or fish.

22. The method of claim 20 wherein the at least one chute is angled at 32 degrees to the plane of the cutting blade.

23. (canceled)

24. (canceled)
